(19) United States
(12) Patent Application Publication
(10) Pub. No.: US 2020/0143274 A1
(43) Pub. Date: May 7, 2020

(54) SYSTEM AND METHOD FOR APPLYING ARTIFICIAL INTELLIGENCE TECHNIQUES TO RESPOND TO MULTIPLE CHOICE QUESTIONS

(71) Applicant: KIRA INC., Toronto (CA)

(72) Inventors: Radha CHITTA, Toronto (CA); Alexander Karl HUDEK, Toronto (CA)

(21) Appl. No.: 16/182,541

(22) Filed: Nov. 6, 2018

(51) Int. Cl. G06N 5/04; G06N 99/00

(52) U.S. Cl. CPC G06N 5/048; G06N 99/005

(57) ABSTRACT

A system for answering multiple choice questions includes at least one processor configured to create a question answering model using a training data set. The system is configured to create a balanced data from the imbalanced training data set. The balancing of the imbalanced training data set is achieved by generating synthetic instances of at least one minority category, among a plurality of categories into which the training data set is categorized.

### BACKGROUND

### Field

The disclosed subject matter in general relates to artificial intelligence systems. More particularly, but not exclusively, the subject matter relates to artificial intelligence systems for answering multiple choice questions.

### Discussion of Related Field

Over the years substantial research has taken place to develop artificial intelligence based systems for answering questions based on contents that may be available in documents. Broadly, there can be questions to which answers could be developed in the form of sentences that are generated by processing contents of a document. On the other hand, there can be multiple choice questions, wherein one of the answers may be selected as the most appropriate based on the contents of a document.

Systems that can predict answers to multiple choice questions may be useful in a variety of industries. As an example, a system that can reliably predict answers to vital questions as part of legal due diligence by analysing contracts, would be useful. However, the adoption of such system will be feasible when the system can reliably predict answers to multiple choice questions.

Reliability of such systems is largely based on the quality of question answering model which is used for predicting answers. The quality of such models may in turn be based on quality of training data set used for developing such model. However, more often than not, training data may be imbalanced. As an example, reliability of a model may not be acceptable, if the model is trained using a training data set that comprises 90 instances where answer is “yes” and 10 instances where answer is “no”. Generally, to rectify such an imbalance in data, the system is trained using large amount of training data. However, obtaining and pre-processing such large amount of training data may not be feasible.

In light of the foregoing discussion, there may be a need for an improved technique for answering multiple questions.

### SUMMARY

In one aspect, a system is provided for answering multiple choice questions. The system includes at least one processor configured to create a question answering model using a training data set. The system is configured to create balanced data from the imbalanced training data set. The balancing of the imbalanced training data set is achieved by generating synthetic instances of at least one minority category, among a plurality of categories into which the training data set is categorized.

In another aspect, a method is provided for answering multiple choice questions. The method comprising creating a question answering model. The question answering model is created by balancing imbalance present in a training data. The balancing of the training data set is achieved by generating synthetic instances of at least one minority category, among a plurality of categories into which the training data set is categorized.

In yet another aspect, a non-transitory computer readable medium is provided for answering multiple choice questions. The non-transitory computer readable medium has stored thereon software instructions that, when executed by a processor, cause the processor to create a question answering model. The model is created by balancing imbalance present in a training data. The balancing of the training data set is achieved by generating synthetic instances of at least one minority category, among a plurality of categories into which the training data set is categorized.

### BRIEF DESCRIPTION OF THE DRAWINGS

This disclosure is illustrated by way of example and not limitation in the accompanying figures. Elements illustrated in the figures are not necessarily drawn to scale, in which like references indicate similar elements and in which:

FIG. 1 is a block diagram illustrating software modules of a system 100 for answering multiple choice questions, in accordance with an embodiment.

FIG. 2 is a flowchart of an exemplary method of creating a question answering model for answering multiple choice questions, in accordance with an embodiment.

FIG. 3 is a flowchart of an exemplary method of answering multiple choice questions using the question answering model, in accordance with an embodiment.

FIG. 4 is a block diagram illustrating hardware elements of the system 100 of FIG. 1, in accordance with an embodiment.

### DETAILED DESCRIPTION

The following detailed description includes references to the accompanying drawings, which form part of the detailed description. The drawings show illustrations in accordance with example embodiments. These example embodiments are described in enough detail to enable those skilled in the art to practice the present subject matter. However, it may be apparent to one with ordinary skill in the art that the present invention may be practised without these specific details. In other instances, well-known methods, procedures and components have not been described in detail so as not to unnecessarily obscure aspects of the embodiments. The embodiments can be combined, other embodiments can be utilized, or structural and logical changes can be made without departing from the scope of the invention. The following detailed description is, therefore, not to be taken in a limiting sense.

In this document, the terms “a” or “an” are used, as is common in patent documents, to include one or more than one. In this document, the term “or” is used to refer to a non-exclusive “or”, such that “A or B” includes “A but not B”, “B but not A”, and “A and B”, unless otherwise indicated.

It should be understood, that the capabilities of the invention described in the present disclosure and elements shown in the figures may be implemented in various forms of hardware, firmware, software, recordable medium or combinations thereof.

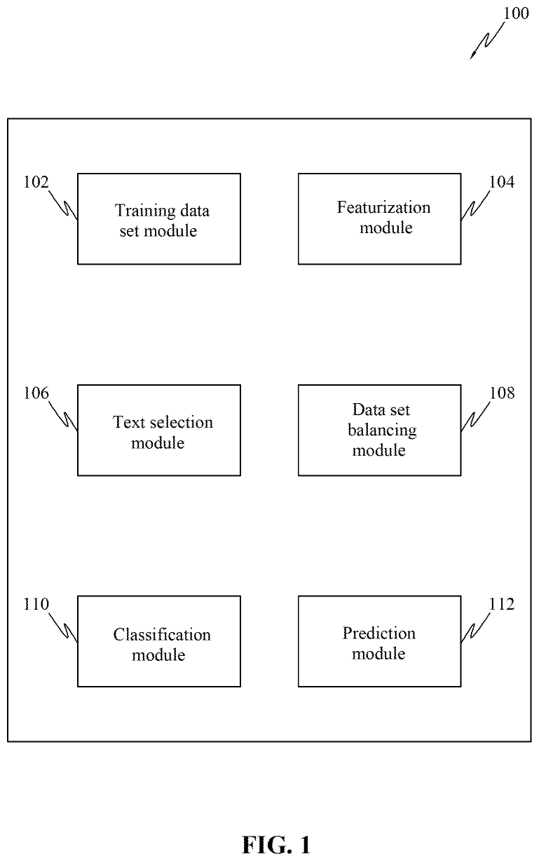

Referring to FIG. 1, a system 100 is provided for answering multiple choice questions for due diligence. The system 100 may comprise a training data set module 102, a featurization module 104, a text selection module 106, a data set balancing module 108, a classification module 110 and a prediction module 112.

The training data set module 102 may include documents, questions and answers, in accordance with an embodiment. Example of documents includes contracts, such as, license agreements, power of attorney, acquisition agreements, merger agreements, employment agreements, service-level agreements, insurance agreements and so on. The questions may be based on the content of the documents or may be about the contract. Further, the answers may be answers corresponding to these questions. As an example, the question may be “Whether the contract is assignable without consent?” to which the answer may be either a “yes” or a “no”. The portion or contents of the document from which the answer (among a plurality of options) is derivable may be referred to as evidence.

In an embodiment, the evidence, which may be a portion of the contract that are most relevant to a question and may be identified by an individual. Hence, in this embodiment, the training data set module 102 also includes evidences in the document that are identified by an individual. Alternatively, pre-identified evidences in a document may be fed to the training data set module 102. The pre-identified evidences may technologically identified as well.

The featurization module 104 may be configured to represent the contracts and the questions as vector representations. The contracts may be treated as a set of words or phrases and converted into unique vector representations. The unique vector representations of contracts may reflect the frequency of each word or phrase. The unique vector representation of contract may also be vectors of numbers that represent the meaning of the word or the phrase. Similarly, the questions may be converted into unique vector representation by treating the questions as a set of words or phrases. The unique vector representation of questions may reflect the frequency of each word or phrase. Also, the unique vector representation of questions may be vectors of numbers that represent the meaning of the word or the phrase. The vector representations of the contracts and vector representations of the questions may be referred to as contract features and question features, respectively.

The text selection module 106 may be configured to extract the evidence from the contract, in accordance with an embodiment. The text selection module 106 may extract the evidence from the contract features based on the question features. The output of the text selection module 106 may comprise the vector representations of the evidence. It shall be noted that, as discussed earlier, evidence may be pre-identified and fed to the training data set module 102. The evidence, whether pre-identified or identified by the text selection module 106, may undergo featurization, thereby resulting in corresponding vector representations.

The data set balancing module 108 may create a balanced training data set from the imbalanced training data set. A training data set may be said to be imbalanced is there exists substantial inequality between the majority class of instances and the minority class of instances. As an example, the question “Can this contract be assigned without consent?” may be answered either as “yes” or “no”. There may be 90 instances where the answer may be “yes” and, only 10 instances where the answer may be “no”. The 90 instances where the answer may be ‘yes’ may constitute a majority class of instances, whereas the 10 instances where the answer may be ‘no’ may constitute a minority class of instances. Such an imbalanced training data may lead to an inaccurate and unreliable output when the system tries to predict answer to multiple choice questions. The data set balancing module 108 is configured to counter the effect of the imbalanced training data on the output by converting the imbalanced training data set to a balanced training data set. Example of how the balancing is carried out in discussed later in this document.

The classification module 110 may be configured to create a question answering model. The classification module 110 may be trained to learn a mapping between the contracts, questions and answers wherein a mapping answer=f (evidence; question). The mapping answer may be referred to as the question answering model. As an example, the question answering model may comprise the question “Can this contract be assigned without consent?” to which the answer may be “yes” or “no”, depending on the evidences.

The prediction module 112 may be configured to predict an answer to a multiple choice question using the question answering model discussed above. The prediction module 112 may receive, as input, evidence features, which are extracted from the contract features based on the question features. The prediction module 112 may further receive the question features as input. The inputs are processed by the prediction module 112 using the question answering model, wherein mapping answer=f (evidence; question), to predict an answer to a multiple choice question.

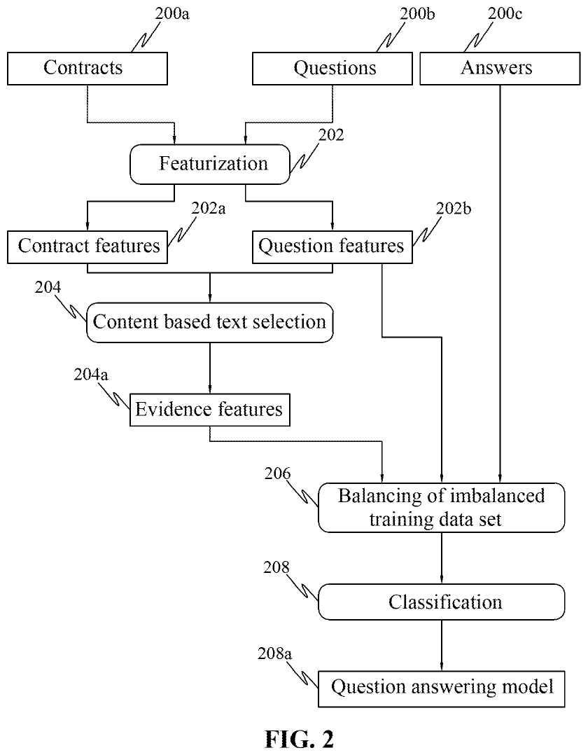

Having discussed the various software modules of the system 100, the method of creating a question answering model is discussed with reference to FIG. 2.

As an example, the contracts 200a and the questions 200b may first pass through the featurization module 104. The featurization module 104 may vectorize the questions 200b and the contracts 200a and may generate the question features 202b and the contract features 202a. The question features 202b and the contract features 202a may then pass through the text selection module 106, wherein the evidence may be extracted from the contract. The text selection module 106 may generate the evidence features 204a. The evidence features 204a and the answers 200c may then pass through data set balancing module 108. The data set balancing module 108 may generate a balanced training data set from the imbalanced training data set using SMOTE algorithm. The balanced training data set may then pass through classification module 110 wherein, the classification algorithm may learn a mapping between the evidence, question and the answer. The classification module 110 may generate the question answering module 208a. The question answering module may be used by the system 100 to predict answers for the user defined questions.

Having provided an overview of the steps involved in creating a question answering model, each of the steps is discussed in greater detail hereunder.

Referring to a step 202, the training data set may be subjected to featurization, to convert the training data set to unique vector representation. The training data may include contracts 200a, multiple choice questions 200b and answers 200c, in accordance with an embodiment. The training data set, which may be present in the training data set module 102 may be communicated to the featurization module 104. The contracts and the questions may be subjected to featurization by the featurization module 104 to represent each contract and the question as vector representations, as explained earlier.

In an embodiment, the output of the featurization module 104 may be contract features and question features, as indicated in step 202a and 202b. The contract features 202a may constitute the unique vector representations of the contracts 200a, and likewise the question features 202b may constitute the unique vector representations of the questions 200b.

Referring to a step 204, the contract features and question features, may pass through the text selection module 106, wherein a context based text selection algorithm may extract evidence from the contract. The evidence may be the portions of the contract that are most relevant to the question. The context based text selection algorithm may use a statistical modelling method such as Conditional random fields (CRFs). An example of the extraction procedure is published by Adam Roegiest et al. in their publication titles, A dataset and an examination of identifying passages for due diligence, published in International ACM SIGIR Conference on Research & Development in Information Retrieval, pages 465-474, 2018. The output of the text selection module 106 may be evidence features 204a.

In another embodiment, the evidence may be pre-identified, as discussed earlier. Such evidence may also be subjected to featurization.

Referring to a step 206, the evidence features 204a, the question features 202b and the answers 200c may pass through data set balancing module 108, in accordance to an embodiment. The input to the data set balancing module 108 comprising the evidence features 204a, the question features 202b and the answers 200c, may include an imbalanced number of the instances, as discussed earlier. Balanced data set may be generated from the imbalanced data set by the data set balancing module 108. The generation of the balanced data set may be achieved by the implementation of SMOTE (Synthetic Minority Oversampling Technique) algorithm.

The SMOTE algorithm may create several synthetic instances to reduce the imbalance between the majority and minority instances. As an example, an instance “x” in the minority class/category may be identified from imbalanced data points. For each minority instance “x”, its “k” nearest neighbours may be identified and one of them, “xₙₙ” may be randomly selected. The nearest neighbour “xₙₙ” may be from the group of instances in the minority class. The difference between the minority instance “x” and the nearest neighbour “xₙₙ” may then be calculated. The obtained difference between the minority instance “x” and the nearest neighbour “xₙₙ” may then be multiplied by a random number between “0” and “1”. The synthetic observation “x_{new}” may be generated by addition of the multiplied result to the minority instance “x”. The generation of the synthetic observation “x_{new}” may be represented in the form of an equation;

x_{new}=x+r(xₙₙ−x) (1)

wherein,

“x” is the instance in the minority category;

“x_{new}” is the synthetic instance in the minority category;

“xₙₙ” is the instance in the minority category neighbouring the instance “x”; and

“r” is the random number between 0 and 1.

The process described above, may be repeated till the number of the instances of the minority class is approximately equal to the number of the instances of the majority class. According to an embodiment, the output of the data set balancing module 108 may be the balanced data set generated by the SMOTE algorithm.

Referring to a step 208, the balanced data set, generated by the implementation of the SMOTE algorithm, may pass through the classification module 110. The classification module 110 may implement a classification algorithm on the balanced data set. The classification algorithm may learn a mapping wherein the mapping answer=f (evidence, question) between the evidence, question and the answer.

The classification algorithm may be a predictive analysis method such as a logistic regression. The logistic regression for classification may be a binary logistic regression or may be a multinomial logistic regression. The binary logistic regression may be implemented for the answers that may belong to a binary category. The binary category may be a category comprising a positive class and a negative class. The binary logistic regression may predict the probability that the answer belongs to the positive class or the negative class. As an example, the answer to the question “Whether the contract is assignable without consent?” may belong to the category “yes” (positive class) or to the category “no” (negative class). The multinomial logistic regression may be implemented for multiclass outcomes, i.e., with more than two possible outcomes.

The output of the classification module 112 may be the question answering model 208a. The question answering model may be used by the system 100 to predict the answer to user defined multiple choice questions.

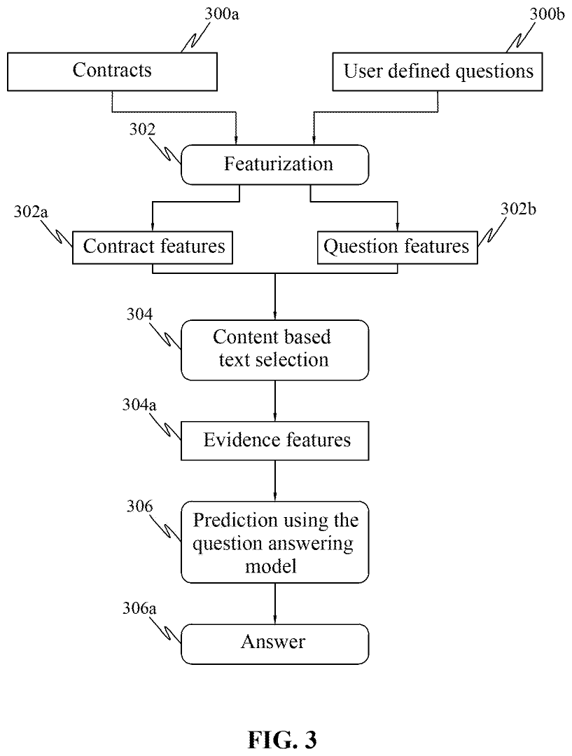

Having discussed the method of creating a question answering model, the method for predicting an answer for a user defined multiple choice question is discussed with reference to FIG. 3.

A contract 300a and a user defined question 300b may first pass through the featurization module 104. The featurization module 104 may vectorize the user defined questions 300b and the contracts 300a, to generate the question features 302b and the contract features 302a. The question features 302b and the contract features 302a may then pass through the text selection module 106, wherein the evidence may be extracted from the contract 300a. The text selection module 106 may generate the evidence features 304a. The evidence features 304a and the question features 302b may then pass through the prediction module 112. The question features 302b and the evidence features 304a may be input to the question answering model to obtain the answer 306a.

Having provided an overview of the steps involved in selecting an answer to a multiple choice question, each of the steps is discussed in greater detail hereunder.

Referring to a step 302, data set may be subjected to featurization, to convert the data set to unique vector representation. The data set may include at least one contract 300a and at least one user-defined question 300b. The vectorization procedure was previously explained with reference to step 202, and a similar technique can be applied here as well. The contract features 302a and the user-defined question features 302b created by the featurization module 104 may pass through the text selection module 106.

At step 304, the text module 106 may extract the evidence from the contract 300a by implementation of the context text selection algorithm. The extraction of the evidence was previously explained with reference to step 204, and a similar technique can be applied here as well.

Referring to a step 306, the evidence features 304a and the question features 302b may pass through the prediction module 112. The prediction module 112 may comprise the question answering model. The evidence features 304a and the question features 302b may be provided as input to the question answer model to obtain the answer. As an example, the question “Can this contract be assigned without consent?” and the evidence may be input to the question answer model. The prediction module 112 may select the answer “yes”, if the contract can be assigned without consent. Alternatively, the selected answer may be “no”, if consent is required for assigning the contract.

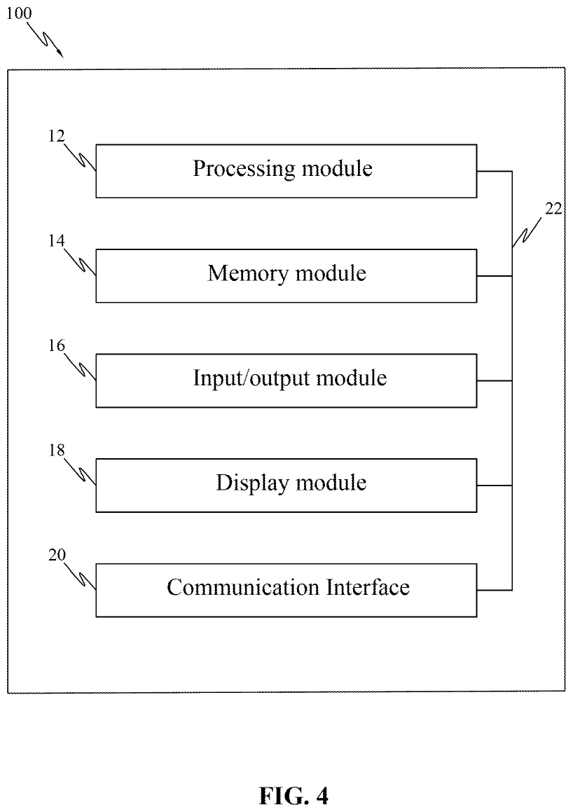

FIG. 4 is a block diagram illustrating hardware elements of the system 100 of FIG. 1, in accordance with an embodiment. The system 100 may be implemented using one or more servers, which may be referred to as server. The system 100 may include a 20 processing module 12, a memory module 14, an input/output module 16, a display module 18, a communication interface 20 and a bus 22 interconnecting all the modules of the system 100.

The processing module 12 is implemented in the form of one or more processors and may be implemented as appropriate in hardware, computer executable instructions, firmware, or combinations thereof. Computer-executable instruction or firmware implementations of the processing module 12 may include computer-executable or machine-executable instructions written in any suitable programming language to perform the various functions described.

The memory module 14 may include a permanent memory such as hard disk drive, may be configured to store data, and executable program instructions that are implemented by the processing module 12. The memory module 14 may be implemented in the form of a primary and a secondary memory. The memory module 14 may store additional data and program instructions that are loadable and executable on the processing module 12, as well as data generated during the execution of these programs. Further, the memory module 14 may be a volatile memory, such as a random access memory and/or a disk drive, or a non-volatile memory. The memory module 14 may comprise of removable memory such as a Compact Flash card, Memory Stick, Smart Media, Multimedia Card, Secure Digital memory, or any other memory storage that exists currently or may exist in the future.

The input/output module 16 may provide an interface for input devices such as computing devices, keypad, touch screen, mouse, and stylus among other input devices; and output devices such as speakers, printer, and additional displays among others. The input/output module 16 may be used to receive data or send data through the communication interface 20.

The display module 18 may be configured to display content. The display module 18 may also be used to receive input. The display module 18 may be of any display type known in the art, for example, Liquid Crystal Displays (LCD), Light Emitting Diode (LED) Displays, Cathode Ray Tube (CRT) Displays, Orthogonal Liquid Crystal Displays (OLCD) or any other type of display currently existing or which may exist in the future.

The communication interface 20 may include a modem, a network interface card (such as Ethernet card), a communication port, and a Personal Computer Memory Card International Association (PCMCIA) slot, among others. The communication interface 20 may include devices supporting both wired and wireless protocols. Data in the form of electronic, electromagnetic, optical, among other signals may be transferred via the communication interface 20.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus, the scope of the invention should be determined by the appended claims and their legal equivalents rather than by the examples given.

What is claimed is:

1. A system for answering multiple choice questions, the system comprising at least one processor configured to create a question answering model, wherein,
imbalance in a training data set is balanced; and
balancing of the training data set is achieved by generating synthetic instances of at least one minority category, among a plurality of categories into which the training data set is categorized.

2. The system according to claim 1, wherein the processor is configured to generate the synthetic instances of the at least one minority category using Synthetic Minority Oversampling Technique (SMOTE).

3. The system according to claim 2, wherein the synthetic instances are generated using the formula:
x_{new}=x+r(xₙₙ−x)
wherein,
“x” is an instance in the minority category;
“x_{new}” is a synthetic instance in the minority category;
“xₙₙ” is an instance in the minority category neighbouring the instance “x”; and
“r” is a number between 0 and 1.

4. The system according to claim 1, wherein the processor is further configured to pass a generated data set, which is obtained by balancing of the training data set, to a classification algorithm to create the question answering model, wherein the classification algorithm learns a mapping as:
answer=f(evidence,question).

5. The system according to claim 4, wherein the classification algorithm is logistic regression.

6. The system according to claim 1, wherein the processor is configured to answer multiple choice questions using the question answering model.

7. A method for answering multiple choice questions, the method comprising creating a question answering model, wherein question answering model is created by balancing imbalance present in a training data, wherein balancing of the training data set is achieved by generating synthetic instances of at least one minority category, among a plurality of categories into which the training data set is categorized.

8. The method according to claim 7, wherein the synthetic instances of the at least one minority category are generated using Synthetic Minority Oversampling TEchnique (SMOTE).

9. The method according to claim 8, wherein the synthetic instances are generated using the formula:
x_{new}=x+r(xₙₙ−x)
wherein,
“x” is an instance in the minority category;
“x_{new}” is a synthetic instance in the minority category;
“xₙₙ” is an instance in the minority category neighbouring the instance “x”; and
“r” is a number between 0 and 1.

10. The method according to claim 7, further comprising passing a generated data set, which is obtained by balancing of the training data set, to a classification algorithm to create the question answering model, wherein the classification algorithm learns a mapping as:
answer=f(evidence;question).

11. The method according to claim 10, wherein the classification algorithm is logistic regression.

12. The method according to claim 7, further comprising, answering multiple choice questions using the question answering model.

13. A non-transitory computer readable medium having stored thereon software instructions that, when executed by a processor, cause the processor to create a question answering model, by executing the steps comprising, balancing imbalance present in a training data, wherein balancing of the training data set is achieved by generating synthetic instances of at least one minority category, among a plurality of categories into which the training data set is categorized.
